(19) United States
(12) Patent Application Publication
(10) Pub. No.: US 2006/0240347 A1
(43) Pub. Date: Oct. 26, 2006

(54) Magnetic Monocomponent developing toner and image forming method

(76) Inventor: Koji Kuramashi, Osaka (JP)

Correspondence Address: Arthur G. Schaier;Carmody & Torrance LLP, P. O. Box 1110, 50 Leavenworth Street, Waterbury, CT, 06721-1110, US

(21) Appl. No.: 11/405,759

(22) Filed: Apr. 18, 2006

(30) Foreign Application Priority Data
Apr. 21, 2005 (JP) 2005-123907

(51) Int. Cl. G03G 9/083

(52) U.S. Cl. 430/106.1; 430/108.4; 430/109.4; 430/122; 430/124; 430/111.4

(57) ABSTRACT

The present invention provides a magnetic monocomponent developing toner which can acquire the stable transport performance for a long period and an image forming method which uses the magnetic monocomponent developing toner. In a magnetic monocomponent developing toner comprising 45 to 65 weight % of a binder resin, 1 to 15 weight % of wax, and 30 to 50 weight % of magnetic powder with respect to a total quantity of the toner and an image forming method which uses the magnetic monocomponent developing toner, the binder resin contains a first polyester resin having a weight average molecular weight peak within a range from 1.0×10⁴ to 5.0×10⁴ and a second polyester resin having a weight average molecular weight peak within a range from 1.0×10⁶ to 5.0×10⁶, and contains 5 to 30 weight % of tetrahydrofuran-insoluble component with respect to a total quantity of the binder resin, the wax is made of an ester compound or a Fischer Tropsch wax, and the wax has melting property that a temperature range from starting of melting to finishing of melting is set to 70 to 95° C.

### TECHNICAL FIELD

The present invention relates to a magnetic monocomponent developing toner which is used in an image forming apparatus such as a copying machine, a printer, a facsimile or a composite machine which uses an electrophotographic method, and an image forming method which uses the magnetic monocomponent developing toner. The present invention particularly relates to, in an image forming apparatus which uses a magnetic jumping method, a magnetic monocomponent developing toner which obviates drawbacks such as the aggregation of toner attributed to the temperature elevation of a machine or a developing unit even when the printing is continuously performed under a high temperature and high moisture and exhibits excellent heat resistance and excellent fixing property, and an image forming method which uses the magnetic monocomponent developing toner.

### RELATED ART

A developing method adopted by an image forming apparatus such as a copying machine, a printer, a facsimile, a composite machine thereof or the like which uses an electrophotographic method is classified into a monocomponent developing method which uses a monocomponent developer and a two-component developing method which uses a two-component developer.

However, since the two-component developing method uses carrier and requires a mechanism which controls a mixing ratio of toner and carrier, it has been considered in general that the miniaturization and the reduction of weight of the image forming apparatus are difficult. Accordingly, the monocomponent developing method is considered suitable to cope with a demand for the miniaturization, the reduction of weight and the low power consumption along with the recent personalization of the image forming apparatus.

Further, among various monocomponent developing methods, a magnetic jumping method has attracted attentions as a developing method which can form a clear image without generating the aggregation of toner particles since sufficient magnetic charge is obtained by increasing chances that a developing sleeve and the toner are brought into contact with each other. That is, due to a magnetic force of a fixing magnet which is arranged in the inside of a developer carrying body, the magnetic toner is adhered onto the developing sleeve and, at the same time, a thin toner layer is formed by restricting a layer thickness of the toner by a developer layer thickness restricting member. Further, in this method, in a state that the developing sleeve is arranged extremely close to a photoreceptor drum, a developing bias voltage which is formed of a AC component and a DC component is applied to the photoreceptor drum thus generating a potential difference between an electrostatic latent image on the photoreceptor drum and the developing sleeve thus performing the development.

With respect to the developing method which uses such a magnetic jumping method, there has been proposed magnetic toner which includes a binder resin, a magnetic body and a charge control agent, wherein a periphery of the magnetic body is covered with a resin layer in which the charge control agent or the like is dispersed, and a weight average molecular weight of a resin which constitutes a resin layer is set larger than a weight average molecular weight of the binder resin (see patent document 1).

Further, there has been also proposed a developing method in which a photoreceptor which holds an electrostatic latent image on the surface thereof and a non-magnetic sleeve which carries magnetic toner on a surface thereof and includes a magnet in the inside thereof are arranged to face each other with a gap equal to or more than a thickness of the magnetic toner layer in a developing portion therebetween, a photoreceptor and the sleeve are rotated in the same direction, and an AC field having frequency of 1 KHz or below is applied to alternate an electric field in the developing gap not only in an image portion but also non-image portion, wherein a thermo-degradation capsule toner which contains magnetic powder is used as the magnetic toner (see patent document 2)

[Patent document 1] JP5-61248A (Claims)

[Patent document 2] JP5-107931A (Claims)

### DISCLOSURE OF THE INVENTION

### Problems to be Solved by the Invention

However, the magnetic toner described in patent document 1 aims at the prevention of the occurrences such as fogging, stripes or the like by achieving the uniform charging which is obtained by preventing the exposure of magnetic body by determining a molecular weight of the binder resin. However, when the magnetic toner is used in a developing unit such as a developing unit which includes a spiral member as an agitating and transporting member, for example, when the magnetic toner is used in a high speed image forming apparatus which exhibits a line speed of 400 mm/second, there has been a drawback that favorable fixing property is hardly obtained.

Further, the developing method described in patent document 2 aims at both of excellent fixing property and prolonged life time by forming the magnetic toner using the thermo-degradation capsule toner. However, when the stress is continuously applied to the magnetic toner by the spiral developing unit or the like under the high-temperature environment of 30° C. or more, there has been a drawback that defects such as the aggregation of the toner, longitudinal stripes on images and the like are liable to be easily generated.

Further, there has been also found a drawback that the magnetic toners described in patent document 1 and patent document 2 exhibit insufficient fixing property with respect to a printing paper or the like. However, in an attempt to enhance the fixing property of the magnetic toner by lowering the softening point of the binder resin, in general, the toner aggregation propensity is increased when the printing is continuously performed under a high temperature and high moisture and hence, there has been a drawback that not only the formation of a favorable image becomes difficult but also the fixing property with respect to the printing paper or the like becomes further insufficient.

Accordingly, inventors of the present invention have extensively studied these drawbacks of the related art and have found that with the combined use of a predetermined binder resin and a predetermined wax, even when printing is performed continuously under a high temperature and high moisture, drawbacks such as the aggregation of the toner attributed to the temperature elevation of a machine or a developing unit are not generated and, at the same time, excellent fixing properties are obtained with respect to a printing paper or the like thus completing the present invention.

That is, it is an object of the present invention to provide a magnetic monocomponent developing toner which is optimum to a high-speed image forming apparatus which includes a developing unit having an agitating and transporting member such as a spiral member and which is excellent in both of heat resistance and fixing property which are properties contradictory to each other, and an image forming method which uses such magnetic monocomponent developing toner

### Means for Solving the Problem

According to the present invention, there is provided a magnetic monocomponent developing toner which includes 45 to 65 weight % of a binder resin, 1 to 15 weight % of wax, and 30 to 50 weight % of magnetic powder with respect to a total quantity of the toner, wherein the binder resin contains a first binder resin having a weight average molecular weight peak within a range from 1.0×10⁴ to 5.0×10⁴ and a second binder resin having a weight average molecular weight peak within a range from 1.0×10⁶ to 5.0×10⁶, and contains 5 to 30 weight % of tetrahydrofuran-insoluble component with respect to a total quantity of the binder, the wax is made of an ester compound or a fischer tropsch wax, and the wax has melting property that a temperature range from starting of melting to finishing of melting is set to 70 to 95° C. thus overcoming the above-mentioned drawbacks.

That is, due to the combined use of the predetermined binder resin and the predetermined wax, the toner can obtain the excellent heat resistance and excellent fixing property and hence, even when printing is continuously performed under a high temperature and high moisture, no drawbacks such as the aggregation of the toner attributed to the temperature elevation of a machine or a developing unit are generated and, at the same time, the toner can obtain the excellent fixing property with respect to a printing paper or the like.

However, in acquiring balance between the excellent heat resistance and the excellent fixing property, it may be preferable that the second binder resin which includes the peak of the weight average molecular weight at a high molecular weight side contains the tetrahydrofuran-insoluble component.

Further, in forming the magnetic monocomponent developing toner of the present invention, it is desirable that a softening point of the first binder resin is set to less than 120° C. and, at the same time, a softening point of the second binder resin is set to 120° C. or more.

By forming the magnetic monocomponent developing toner while controlling the softening points of a plurality of binder resins in this manner, it may be possible to acquire balance between the further excellent heat resistance and the excellent fixing property in a stable manner.

Further, in forming the magnetic monocomponent developing toner of the present invention, it is desirable that the first binder resin and the second binder resin are respectively formed of a first polyester resin and a second polyester resin, wherein an acid value of the first polyester resin is less than 6 mgKOH/g and, at the same time, an acid value of the second polyester resin is equal to or more than 6 mgKOH/g.

By forming the magnetic monocomponent developing toner while controlling the respective acid values of a plurality of polyester resins, it may be possible to enhance the compatibility of the plurality of polyester resins and, at the same time, it may be possible to acquire balance between the further excellent heat resistance and the further excellent fixing property in a stable manner.

Further, in forming the magnetic monocomponent developing toner of the present invention, it is desirable that the second polyester resin is formed of a partially cross-linked substance of a polyester resin which contains a bisphenol-A propylene oxide compound as an alcoholic component and, at the same time, the second polyester resin contains 10 to 50 weight % of tetrahydrofuran-insoluble component with respect to a total quantity thereof.

Due to such a formation of the toner, while ensuring the stable acquisition of balance between the further excellent heat resistance and the further excellent fixing property, it is also possible to enhance the compatibility of the second polyester resin with the first polyester resin.

Further, in forming the magnetic monocomponent developing toner of the present invention, it is desirable that the first polyester resin is a polyester resin which contains a bisphenol-A propylene oxide compound as an alcoholic component and, at the same time, a content of the tetrahydrofuran-insoluble component is 1 weight % or less_with respect to a total quantity of the first polyester resin.

Due to such a formation of the toner, it may be possible to obtain further excellent fixing property and, at the same time, the compatibility of the first polyester resin with the second polyester resin can be also enhanced.

Further, in forming the magnetic monocomponent developing toner of the present invention, it is desirable that the first polyester resin is a polyester resin which contains at least one kind selected from a group consisting of boletic acid, terephthalic acid and trimellitic acid as an acid component.

Due to such a formation of the toner, in manufacturing the first polyester resin, a reaction speed at the time of performing a condensation reaction between an alcoholic component and an acid component can be properly controlled thus producing toner which exhibits the excellent formability.

Further, in forming the magnetic monocomponent developing toner of the present invention, it is desirable that the second polyester resin is a polyester resin which contains at least one kind selected from a group consisting of succinic acid, terephthalic acid and trimellitic acid as an acid component.

Due to such a formation of the toner, in manufacturing the second polyester resin, a reaction speed at the time of performing a condensation reaction between an alcoholic component and an acid component can be properly controlled thus producing toner which exhibits the excellent formability.

Further, in forming the magnetic monocomponent developing toner of the present invention, it is desirable that a glass transition point of the first binder resin is set to a value which falls within a range from 55° C. to 65° C. and, at the same time, a glass transition point of the second binder resin is set to a value which falls within a range from 45° C. to 55° C.

Due to such a formation of the toner, it may be possible to easily control a glass transition point of the whole binder resin based on a mixing ratio of a plurality of binder resins thus producing toner which exhibits excellent balance between heat resistance and fixing property.

Further, in forming the magnetic monocomponent developing toner of the present invention, it is desirable that a glass transition point of the binder resin is set to a value which falls within a range from 51 to 55° C.

By forming the magnetic monocomponent developing toner while controlling the glass transition point of the binder resin in this manner, it may be possible to further enhance the balance between heat resistance and fixing property.

Further, in forming the magnetic monocomponent developing toner of the present invention, it is desirable that a mixing ratio between the first binder resin and the second binder resin is set to a value which falls within a range from 10:90 to 50:50.

Due to such a formation of the toner, it may be possible to control the balance between the heat resistance and fixing property within a predetermined range.

Further, in forming the magnetic monocomponent developing toner of the present invention, it is desirable that a 140 mesh passing ratio in a powder test after heat treatment at a temperature of 50° C. for 100 hours is 90% or more.

By controlling the property of the toner in the powder test in this manner, it may be possible to provide the further optimum magnetic monocomponent developing toner to a high speed image forming apparatus provided with a developing unit which includes an agitating and transporting member.

Further, in forming the magnetic monocomponent developing toner of the present invention, it is desirable that the toner further contains hydrophobic silica as an additive and, at the same time, an addition quantity of the hydrophobic silica is set to a value which falls within a range from 0.5 to 2.0 weight % with respect to the total quantity of the toner.

Due to such a formation of the toner, it may be possible to acquire the further enhanced balance among heat resistance, fixing property and fluidity.

Further, in forming the magnetic monocomponent developing toner of the present invention, it is desirable that the toner further contains metal oxide as an additive and, at the same time, an addition quantity of the metal oxide is set to a value which falls within a range from 1.0 to 3.0 weight % with respect to the total quantity of the toner.

Due to such formation of the toner, it may be possible to acquire the further enhanced balance among heat resistance, fixing property and abrasive property.

Further, according to another aspect of the present invention, there is provided an image forming method which is characterized in that the above-mentioned magnetic monocomponent developing toner is used in a developing unit which includes a developer carrying body which carries a developer and transports the developer to a developing region, and a developer layer thickness restricting member which restricts a layer thickness of the developer carried on the developer carrying body, and arranges a magnetic body in the vicinity of the developer carrying body.

That is, by carrying out such an image forming method, even under an environment in which stress attributed to a magnetic force is liable to be easily applied to the toner, the toner can acquire balance between excellent heat resistance and excellent fixing property.

Further, in carrying out the image forming method of the present invention, it may be preferable that the developing unit includes an agitating and transporting member which transports the developer in the rotary shaft direction.

By carrying out the image forming method in this manner, even under an environment in which a shearing stress attributed to the agitating and transporting member is liable to be easily applied to the toner, the toner can acquire balance between excellent heat resistance and excellent fixing property.

### BRIEF EXPLANATION OF THE DRAWINGS

FIG. 1 is a view showing a relationship between a gel fraction and heat resistance of a binder resin.

FIG. 2 is a view showing a relationship between a weight average molecular weight and fixing property of a first polyester resin.

FIG. 3 is a view showing a relationship between the weight average molecular weight and heat resistance of the first polyester resin.

FIG. 4 is a view showing a relationship between a weight average molecular weight and fixing property of a second polyester resin.

FIG. 5 is a view showing a relationship between a weight average molecular weight and heat resistance of the second polyester resin.

FIG. 6 is a view showing a relationship between a glass transition point (Tg) and heat resistance of the binder resin.

FIG. 7 is a view showing a relationship between the glass transition point (Tg) and fixing property of the binder resin.

FIG. 8 is a view showing a relationship between intermediate temperature between starting of melting and finishing of melting and heat resistance of waxes.

FIG. 9 is a view showing a relationship between the intermediate temperature between starting of melting and finishing of melting and fixing property of waxes.

FIG. 10 is a view showing a relationship between a content of silica and heat resistance.

FIG. 11 is a view showing a relationship between a content of silica and fixing property.

FIG. 12 is a view showing a relationship between a content of titanium oxide and the heat resistance.

FIG. 13 is a view showing a relationship between a content of titanium oxide and the fixing property.

FIG. 14 is a schematic view showing a developing unit according to the present invention.

FIG. 15 is a view for explaining a spiral member and a toner removing member.

FIG. 16 is a view for explaining an image forming apparatus.

### BEST MODE FOR CARRYING OUT THE INVENTION

Hereinafter, embodiments on a magnetic monocomponent developing toner according to the present invention and an image forming method which uses the magnetic monocomponent developing toner will be explained in detail. However, it is needless to say that the present invention is not limited to the description of such magnetic monocomponent developing toner and the image forming method.

### First Embodiment

A first embodiment is directed to a magnetic monocomponent developing toner which includes 45 to 65 weight % of a binder resin, 1 to 15 weight % of wax and 30 to 50 weight % of magnetic powder with respect to a total quantity of the toner, wherein the binder resin contains a first polyester resin having a weight average molecular weight peak within a range from 1.0×10⁴ to 5.0×10⁴ and a second polyester resin having a weight average molecular weight peak within a range from 1.0×10⁶ to 5.0×10⁶ as the binder resin and, at the same time, and contains 5 to 30 weight % of a tetrahydrofuran-insoluble component with respect to the total quantity of the binder resin and, the wax is made of an ester compound or a Fischer Tropsch wax and, at the same time, the wax has melting property that a temperature range from starting of melting to finishing of melting is set to 70 to 95° C.

1. Basic Constitution

As the basic constitution of a developer which is used in the first embodiment, inorganic fine particles may preferably be added to toner particles which are formed of the binder resin, the waxes, a charge control agent and magnetic powder.

(1) Binder Resin

(1)-1 Kind

Although a kind of the binder resin is not particularly limited, it may be preferable to use a thermoplastic resin such as, for example, a styrene resin, an acrylic resin, styrene-acrylic copolymer, a polyethylene resin, a polypropylene resin, a vinyl chloride resin, a polyester resin, a polyamide resin, a polyurethane resin, a polyvinyl alcohol resin, a vinyl ether resin, a N-vinyl resin, a styrene-butadiene resin or the like.

Here, the constitution of this embodiment is characterized in that the binder resin, that is, the first binder resin or the second binder resin contains 5 to 30 weight % of the tetrahydrofuran insoluble component with respect to the total quantity of the binder resin.

This is because that when a content of the tetrahydrofuran insoluble component is set to a value less than 5 weight %, heat resistance or aggregation prevention resistance of the developer is significantly lowered, while when the content of the tetrahydrofuran insoluble component exceeds 30 weight %, fixing resistance of the developer is significantly lowered.

Accordingly, it may be more preferable that the binder resin contains 6 to 13 weight % of tetrahydrofuran insoluble component with respect to the total quantity of the binder resin and, it may be still more preferable that the binder resin contains 7 to 12 weight % of the tetrahydrofuran insoluble component.

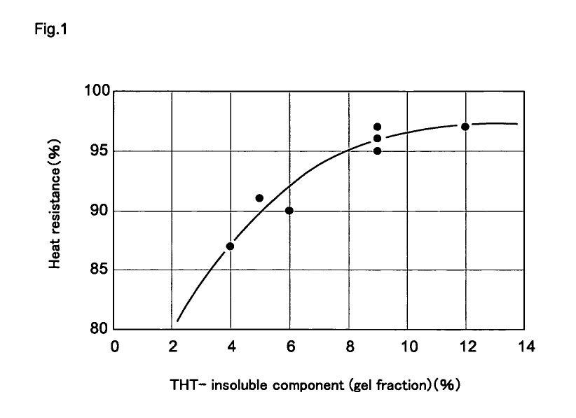

Here, in conjunction with FIG. 1, the influence of the tetrahydrofuran insoluble component of the binder resin with respect to the total quantity of the binder resin is further specifically explained. In FIG. 1, the tetrahydrofuran insoluble component of the binder resin with respect to the total quantity of the binder resin is taken on an axis of abscissas as a gel fraction (%) and heat resistance (%) which is prescribed in example 1 is taken on an axis of ordinates.

As can be easily understood from a characteristic curve shown in FIG. 1, when a content of the gel fraction is 4% or more, the higher the content of the gel fraction, the heat resistance is extremely enhanced. However, when the gel fraction exceeds approximately 8%, there may arise a tendency that heat resistance is saturated. Accordingly, to obtain the predetermined heat resistance, it is effective to use a partially cross-linked material as the binder resin and, at the same time, to limit the tetrahydrofuran insoluble component of the binder resin to the predetermined range.

Here, the tetrahydrofuran-insoluble component (also referred to as “gel ratio” hereinafter) of the binder resin in the toner particles can be measured by using a Soxhlet extractor which uses tetrahydrofuran THF as a solvent. That is, 0.5 to 1.0 g of toner sample is weighed (W₁ g) and is placed in a cylindrical filter (for example, No. 86R made by ToyoRoshi Kaisha, Ltd.) and is extracted by using the Soxhlet extractor using 100 to 200 ml of THF as a solvent for 6 hours. The soluble component which is extracted by the solvent is evaporated and, thereafter, is dried in a vacuum at a temperature of 100° C. for several hours, and a THF-soluble resin component quantity is weighed (W₂ g). When THF-insoluble component of the toner is measured, the weights of components except for resin components such as pigments are obtained as (W₃ g) from the following formula.
THF-insoluble component(%)=[W₁−(W₃+W₂)/(W₁−W₃)]×100 [Formula 1]
(1)-2 Average Molecular Weight

Here, it may be preferable that the binder resin contains a first polyester resin in which a weight average molecular weight peak is set to a value which falls within a range from 1.0×10⁴ to 5.0×10⁴ and a second polyester resin in which a weight average molecular weight peak is set to a value which falls within a range from 1.0×10⁶ to 5.0×10⁶ That is, it may be preferable that the binder resin has two molecular weight peaks (sometimes referred to as low molecular weight peak and high molecular weight peak).

The reason is that when two molecular weight peaks are respectively set to values which fall within the predetermined ranges, it may be possible to obtain excellent fixing property, while heat resistance becomes favorable and hence, in a high speed image forming apparatus provided with a developing unit having a spiral member or the like, even when printing is sequentially carried out at a high temperature and under a high moisture, it may be possible to effectively prevent drawbacks such as toner aggregation due to temperature rise of the machine or the developing unit.

Accordingly, it may be preferable to set the low molecular weight peak to a value which falls within a range from 2.0×10⁴ to 4.0×10⁴ and to set the high molecular weight peak to a value which falls within a range from 2.0×10⁶ to 4.0×10⁶.

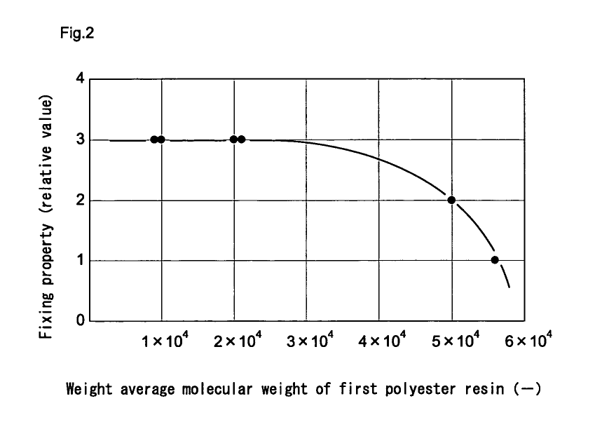

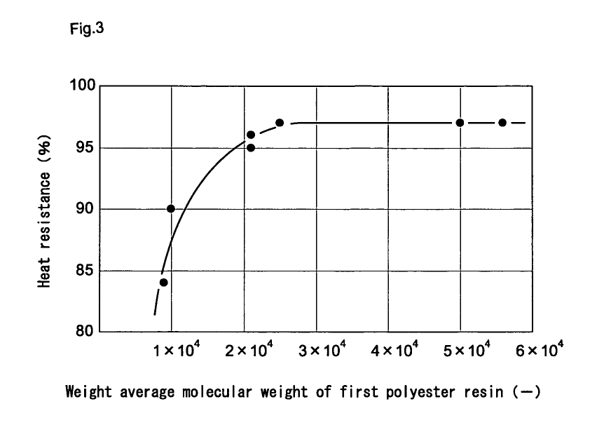

Here, in conjunction with FIG. 2 and FIG. 3, the relationship between the weight average molecular weight of the first polyester resin (non-cross-linked material) having the low molecular weight peak and fixing property and heat resistance which are prescribed in the example 1 is explained.

FIG. 2 shows a characteristic curve which indicates the relationship between the weight average molecular weight of the first polyester resin and fixing property, wherein the weight average molecular weight of the first polyester resin is taken on an axis of abscissas and the fixing property (relative value) which is prescribed in the example 1 is taken on an axis of ordinates.

As can be understood from the characteristic curve shown in FIG. 2, when the weight average molecular weight of the first polyester resin is approximately 1×10⁴, fixing property of the first polyester resin is stable. However, when the weight average molecular weight of first polyester resin is 5×10⁴ or more, the fixing property of the first polyester resin is significantly lowered. Accordingly, to allow the first polyester resin to obtain the predetermined fixing property, it is effective to limit the weight average molecular weight of the first polyester resin to a value less than the predetermined range.

Further, FIG. 3 shows a characteristic curve which indicates the relationship between the weight average molecular weight of the first polyester resin and heat resistance, wherein the weight average molecular weight of the first polyester resin is taken on an axis of abscissas and heat resistance (%) which is prescribed in the example 1 is taken on an axis of ordinates.

As can be understood from the characteristic curve shown in FIG. 3, when the weight average molecular weight of the first polyester resin is set to approximately 5×10⁴, heat resistance of the first polyester resin is stable. However, when the weight average molecular weight of the first polyester resin is set to 1×10⁴ or less, fixing property of the first polyester resin is liable to be significantly lowered. Accordingly, to allow the first polyester resin to obtain the predetermined heat resistance, it is effective to limit the weight average molecular weight of the first polyester resin to a value more than the predetermined range.

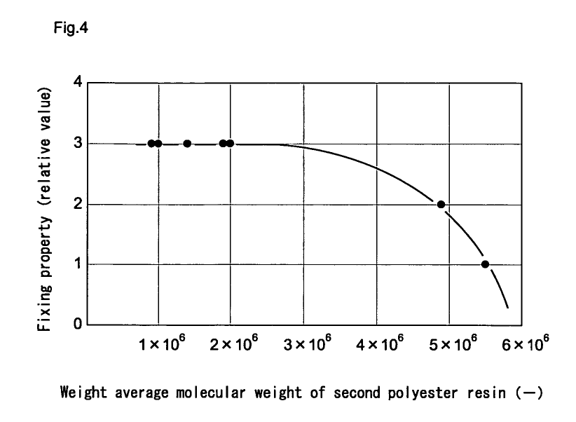

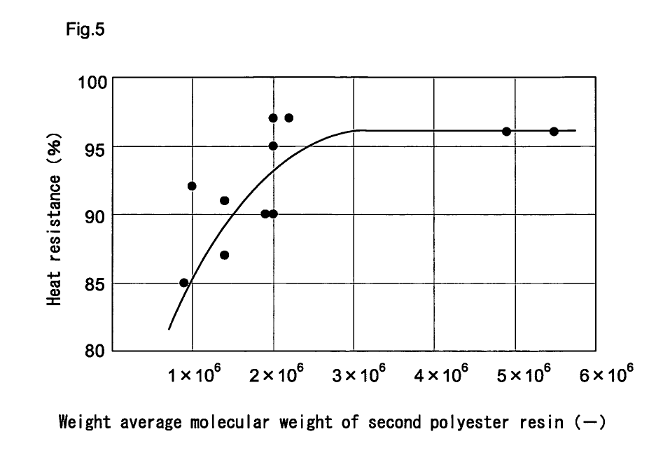

Next, in conjunction with FIG. 4 and FIG. 5, the relationship between a weight average molecular weight of soluble components of the second polyester resin (partially cross-linked material) having a high molecular weight peak and fixing property and heat resistance which are prescribed in the example 1 is explained.

FIG. 4 shows a characteristic curve which indicates the relationship between the weight average molecular weight of the second polyester resin and fixing property, wherein the weight average molecular weight of soluble components of the second polyester resin is taken on an axis of abscissas and the fixing property (relative value) which is prescribed in the example 1 is taken on an axis of ordinates.

As can be understood from the characteristic curve shown in FIG. 4, when the weight average molecular weight of the second polyester resin is approximately 1×10⁶, fixing property of the second polyester resin is stable. However, when the weight average molecular weight is 5×10⁶ or more, fixing property of the second polyester resin is significantly lowered. Accordingly, to allow the second polyester resin to obtain the predetermined fixing property, it is effective to limit the weight average molecular weight of the second polyester resin to a value less than the predetermined range.

Further, FIG. 5 shows a characteristic curve which indicates the relationship between the weight average molecular weight of the soluble components of the second polyester resin and heat resistance, wherein the weight average molecular weight of the soluble components of the second polyester resin is taken on an axis of abscissas and heat resistance (%) which is prescribed in the example 1 is taken on an axis of ordinates.

As can be understood from the characteristic curve shown in FIG. 5, when the weight average molecular weight of the second polyester resin is approximately 5×10⁶, heat resistance of the second polyester resin is stable. However, when the weight average molecular weight of the second polyester resin is 1×10⁶ or less, the heat resistance of the second polyester resin is liable to be significantly lowered. Accordingly, to allow the second polyester resin to obtain the predetermined heat resistance, it is effective to limit the weight average molecular weight of the second polyester resin to a value more than a predetermined range.

Here, such a molecular weight of the binder resin can be obtained by measuring an elution time of the binder resin from a column by using a molecular weight measuring device (GPC) under a measuring condition in which a column temperature is set to 40° C. and THF (tetrahydrofuran) is used as a solvent and, thereafter, by collating the elution time with a calibration curve which is preliminarily formed by using a standard polystyrene resin.

(1)-3 Softening Point

Further, it is desirable that the softening point of the first polyester resin is set to a value less than 120° C. and, at the same time, the softening point of the second polyester resin is set to 120° C. or more.

The reason is that even when the temperature is set to a fixing temperature of approximately 150° C., excellent fixing property can be obtained and, at the same time, heat resistance and dispersibility are improved and hence, in a high-speed image forming apparatus having a developing unit which possesses a spiral member, even when the printing is performed continuously under a high temperature and high moisture condition, it may be possible to effectively prevent drawbacks such as the aggregation of toner caused by the temperature elevation of a machine or a developing unit.

Accordingly, it is more desirable that the softening point of the first polyester resin is set to a value less than 115° C. and, at the same time, the softening point of the second polyester resin is set to 125° C. or more.

Further, as a measuring method of the softening point, for example, a following method which uses a flow tester may be named.

First of all, approximately 1.5 g of toner particles passing sieve of 60 mesh (250 μm of opening) is weighed and, thereafter, the toner particles are pressurized with a load of 100 kg/cm² (9800 kPa) for one minute by using a molder.

Next, by using a flow tester CFT-500D (made by Shimadzu Corporation), a load of 10 Kgf (98N) is applied to the sample, a plunger descending quantity is measured by a temperature elevating method (temperature elevation: 4.0° C./min, die diameter: 1.0 mm, die length: 1.0 mm), and a fluidity curve is obtained thus measuring the softening point.

(1)-4 Acid Value

Further, it is desirable that the acid value of the first polyester resin is set to a value less than 6 mgKOH/g and, at the same time, the acid value of the second polyester resin is set to 6 mgKOH/g or more.

The reason is that by setting the acid value of the first polyester resin to such a value, not only compatibility between the first polyester resin and the second polyester resin is improved but also excellent fixing property can be obtained and, at the same time, heat resistance is improved. Accordingly, in a high-speed image forming apparatus having a developing unit which possesses a spiral member, even when the printing is performed continuously under a high temperature and high moisture condition, it may be possible to effectively prevent drawbacks such as the aggregation of the toner caused by the temperature elevation of a machine or a developing unit.

Accordingly, as a range of the acid value, it may be preferable to set the acid value of the first polyester resin to a value which falls within a range from 0 to 5.0 mgKOH/g, and it is more preferable that the acid value is set to a value which falls within a range from 0.1 to 4 mgKOH/g. On the other hand, it may be preferable to set the acid value of the second polyester resin to a value which falls within a range from 6 to 30 mgKOH/g, and it is more preferable that the acid value is set to a value which falls within a range from 7 to 20 mgKOH/g. Here, the acid values which are defined in the present invention are values obtained by a neutralization titration method which uses KOH, wherein the acid value is defined as the mg number of KOH which is necessary for neutralizing 1.0 g of fats and oils.

(1)-5 Components

Further, it may be preferable that the second polyester resin contains 10 to 50 weight % of a tetrahydrofuran-insoluble component which is a partially cross-linked product of polyester resin having a bisphenol-A propylene oxide compound as an alcohol component with respect to a total quantity of the second polyester resin.

The reason is that when the second polyester resin contains less than 10 weight % of tetrahydrofuran-insoluble component, heat resistance and aggregation resistance of the developer are remarkably lowered. On the other hand, when the tetrahydrofuran-insoluble component contained in the second polyester resin exceeds 50 weight %, fixing property of the developer is remarkably lowered.

Accordingly, it is more preferable that the second polyester resin contains 15 to 40 weight % of tetrahydrofuran-insoluble component which is the partially cross-linked product of the polyester resin and it is still more preferable that the second polyester resin contains 20 to 30 weight % of tetrahydrofuran-insoluble component which is the partially cross-linked product of the polyester resin.

Further, it may be preferable that the first polyester resin is a polyester resin having a bisphenol-A propylene oxide compound as an alcohol component and, at the same time, the first polyester resin contains 1 weight % or less of tetrahydrofuran-insoluble component with respect to a total quantity of the first polyester resin.

The reason is that although fixing property of the developer is affected by a mixing quantity of the first polyester resin, when the content of tetrahydrofuran-insoluble component exceeds 1 weight %, fixing property of the developer is remarkably lowered.

Further, it may be preferable that the second polyester resin is a polyester resin which contains at least one kind of acid component selected from a group consisting of a fumaric acid, a terephthalic acid and a trimellitic acid.

The reason is that, by allowing an ester reaction to be generated by using such an acid component, it may be possible to control a reaction speed to a value which falls within a desired range.

Accordingly, by properly controlling a cross-linking state of the polyester resin which is particularly generated by mixing three acids, it may be possible to realize an excellent compatibility when the second polyester resin is mixed with the first polyester resin.

Further, it may be preferable that the first polyester resin is a polyester resin which has at least one kind of acid component selected from a group consisting of a fumaric acid, a terephthalic acid and a trimellitic acid.

The reason is that, in the same manner as the second polyester resin described above, it may be possible to control a reaction speed by suitably selecting the acid component.

Accordingly, by properly controlling the cross-linking state of the polyester resin which is particularly generated by mixing three acids, it may be possible to realize excellent compatibility when the first polyester resin is mixed with the second polyester resin.

(1)-6 Glass Transition Point

Further, it is desirable that the glass transition point (Tg) of the binder resin falls within a range from 51 to 55° C.

The reason is that when the glass transition point of the binder resin is set to less than 51° C., there is a possibility that the obtained toners are melted to each other thus lowering the preservation stability, while when the glass transition point of the binder resin exceeds 55° C., there is a possibility that the fixing property of the toner becomes lowered.

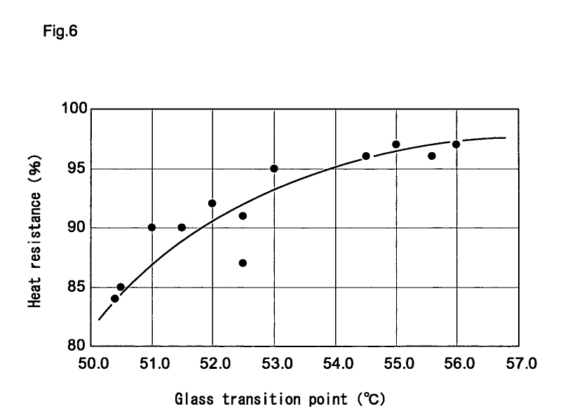

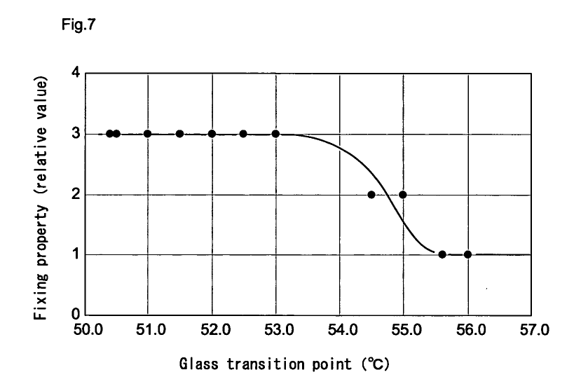

Here, in conjunction with FIG. 6 and FIG. 7, the relationship between a glass transition point (Tg) of the binder resin and heat resistance prescribed in the example 1 and a relationship between the glass transition point (Tg) of the binder resin and fixing property prescribed in the example 1 are explained in further detail.

In FIG. 6, the glass transition point (Tg) of the binder resin is taken on an axis of abscissas and heat resistance (%) which is prescribed in the example 1 is taken on an axis of ordinates.

As can be easily understood from a characteristic curve shown in FIG. 6, when the glass transition point (Tg) of the binder resin is 50° C. or more, the higher the value of the glass transition point (Tg), heat resistance is significantly enhanced. However, when the glass transition point (Tg) of the binder resin exceeds approximately 57° C., the binder resin is liable to be saturated. Accordingly, to allow the toner to obtain a predetermined heat resistance, it is effective to limit the glass transition point (Tg) of the binder resin to a value more than a predetermined value.

Further, in FIG. 7, the glass transition point (Tg) of the binder resin is taken on an axis of abscissas and fixing property (relative value) which is prescribed in the example 1 is taken on an axis of ordinates.

As can be easily understood from a characteristic curve shown in FIG. 7, when the glass transition point (Tg) of the binder resin is approximately 50° C., fixing property is stable. However, when the glass transition point (Tg) of the binder resin exceeds approximately 54° C., fixing property is liable to be lowered easily and rapidly. Accordingly, to allow the toner to obtain a predetermined fixing property, it is effective to limit the glass transition point (Tg) of the binder resin to a value less than a predetermined value.

Here, the glass transition point (Tg) of the binder resin can be obtained based on a changing point of a specific heat by using a differential scanning calorimeter (DSC).

Further, the glass transition point (Tg) of the binder resin can be prescribed by independently controlling the respective glass transition points of the first binder resin and the second binder resin.

To be more specific, it may be preferable to set the glass transition point of the first binder resin to a value which falls within a range from 55 to 65° C. and the glass transition point of the second binder resin is set to a value which falls within a range from 45 to 55° C.

The reason is that, by using a plurality of binder resins having different glass transition points in a mixed form, the glass transition point of the binder resin after mixing can be controlled in response to a mixing ratio of the binder resins. However, when the glass transition points of the respective binder resins largely differ from each other, there may be a case that stable fixing property can not be obtained.

Accordingly, with respect to the range of glass transition point, it may be preferable to set the glass transition point of the first binder resin to a value which falls within a range from 57 to 62° C. and the glass transition point of the second binder resin to a value which falls within a range from 50 to 55° C.

(1)-7 Addition Quantity

Further, it may be preferable to set an addition quantity of the binder resin to a value which falls within a range from 45 to 65 weight % with respect to a total quantity of the developer.

The reason is that, when the addition quantity of the binder resin is less than 45 weight %, there may arise a case in which the obtained toners are melted with each other and preservation stability is lowered, while when the addition quantity of the binder resin exceeds 65 weight %, there may arise a case in which fixing property of the toner is lowered.

Accordingly, it may be preferable to set the addition quantity of the binder resin to a value which falls within a range from 45 to 65 weight % with respect to the total quantity of the developer.

(1)-8 Mixing Ratio

Further, it may be preferable to set a mixing ratio of the first binder resin and the second binder resin to a value which falls within a range from 10:90 to 50:50.

The reason is that, by controlling the mixing ratio to the value within the range, it may be possible to allow the binder resin to exhibit the high fixing property which the first binder resin having a relatively small molecular weight possesses and high heat resistance which the second binder resin having a relatively large molecular weight possesses respectively in a desired balance.

However, when the mixing ratio of the first binder resin is excessively increased, although the binder resin may exhibit excellent fixing property, there may arise a case in which the heat resistance of the binder resin is lowered thus lowering the image property. Further, to the contrary, when the mixing ratio of the second binder resin is excessively increased, although the binder resin may exhibit excellent heat resistance, there may arise a case in which the fixing property of the binder resin is lowered thus also lowering the image property.

Accordingly, as a range of the mixing ratio of the first binder resin and the second binder resin, it may be preferable to set the mixing ratio to a value which falls within a range from 20:80 to 40:60 and, it is more preferable to set the mixing ratio to a value which falls within a range from 25:75 to 35:65.

(2) Waxes

(2)-1 Kind

Further, since the toner is required to satisfy several advantageous effects such as fixing property and offset property, it may be preferable to add predetermined waxes to the toner.

That is, it may be preferable that the wax is an ester compound or a Fischer Tropsch wax.

The reason is that when the wax is the ester compound or the Fischer Tropsch wax, the binder resin exhibits excellent compatibility with the polyester resin or the like.

Here, it is also preferable to use, in addition to such an ester compound or Fischer Tropsch wax, one, two or more kinds of waxes selected from a group consisting of a polyethylene wax, a polypropylene wax, a fluororesin wax, a paraffin wax, a montan wax, a rice wax and the like in a single form or in combination.

(2)-2 Melting Property

Further, with respect to melting property of the waxes, it may be preferable that a temperature range from starting of melting to finishing of melting is set to a value which falls within a range from 70 to 95° C.

The reason is that when the melting starting temperature becomes lower than 70° C., heat resistance is lowered and the toner particles are melted to each other and there may arise a case in which the preservation stability is lowered.

On the other hand, when the melting finishing temperature exceeds 95° C., fixing property is lowered and hence, there may arise a case in which an offset of the toner with respect to a fixing roll (fixing device), image smearing or the like can not be effectively prevented.

Accordingly, with respect to melting property of the waxes, it is more preferable to set the temperature range from starting of melting to finishing of melting to a value which falls within a range from 75 to 90° C., and it is still more preferable to set the temperature range to a value which falls within a range from 76 to 84° C.

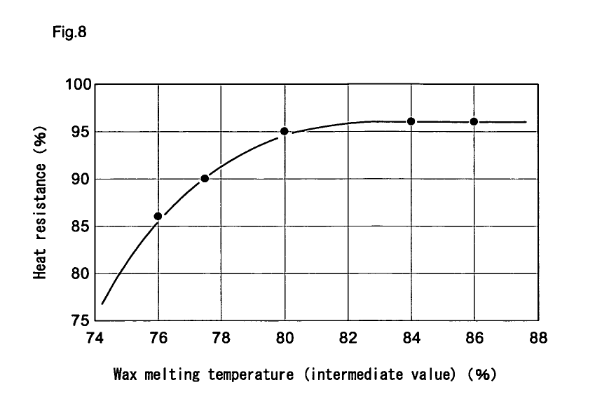

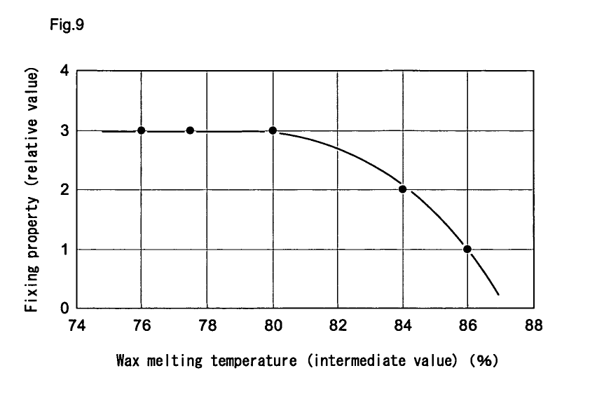

Here, in FIG. 8 and FIG. 9, with respect to melting property of the waxes, relationships between an intermediate temperature (° C.) from the starting of melting to the finishing of the melting and heat resistance and fixing property which are prescribed in the example 1 are respectively shown.

As can be understood from a characteristic curve shown in FIG. 8 and FIG. 9, by controlling the intermediate temperature (° C.) from the starting of melting to the finishing of the melting of the waxes to a value within a predetermined range, it may be possible to respectively obtain excellent properties in heat resistance and fixing property which conflict to each other. Accordingly, to obtain a predetermined heat resistance and fixing property, it is effective to limit the intermediate temperature from the starting of melting to the finishing of the melting of the waxes to a value within a predetermined range.

Here, such melting property of waxes can be measured based on a heat absorption peak profile which is obtained by using a differential scanning calorimeter (DSC).

(2)-3 Addition Quantity

Further, assuming the total quantity of the toner as 100 weight %, it may be preferable to set the addition quantity of the waxes to a value which falls within a range from 1 to 15 weight %.

The reason is that, when the addition quantity of the waxes is less than 1 weight %, there may arise a case in which the offset of the toner with respect to the fixing roll (fixing device), the image smearing or the like can not be effectively prevented.

On the other hand, when the addition quantity of the waxes exceeds 15 weight %, there may arise a case in which heat resistance is lowered and the toners are melted to each other and hence, preservation stability is lowered.

(3) Charge Controlling Agent

Further, from a viewpoint of remarkably enhancing a charge level or a charge rise characteristic (an index which indicates whether the toner is charged to a predetermined charge level or not in a short period) so as to obtain excellent durability, stability or the like, it may be preferable to add a charge controlling agent to the toner.

Although a type of such a charge controlling agent is not specifically limited, it may be preferable to use the charge controlling agent which shows positive charging property such as, a Nigrosine, a quaternary ammonium salt compound, a resin-type charge control agent in which an amine compound is combined with a resin or the like, for example.

Further, assuming a total quantity of the toner as 100 weight %, it may be preferable to set the addition quantity of the charge controlling agent to a value which falls within a range from 1.5 to 15 weight %.

The reason is that when the addition quantity of the charge control agent is less than 1.5 weight %, it is difficult to stably apply charge property to the toner and hence, there may arise a case in which an image density is lowered or durability is lowered. On the other hand, when the addition quantity of the charge control agent exceeds 15 weight %, there may arise a case in which when environment resistance property is lowered, particularly, under a high temperature and high moisture condition, an insufficient charge and a defective image are generated and hence, drawbacks such as the contamination of a photoreceptor or the like are liable to be generated.

(4) Magnetic Powder

Further, the toner may be formed into a magnetic toner by dispersing a known magnetic powder into the toner.

As such magnetic powder, metal powder or alloy powder which exhibits ferromagnetism such as ferrite powder, magnetite powder, iron powder, cobalt powder, nickel powder or a compound powder which contains the ferromagnetic powders can be named.

Further, it may be preferable to set an average particle size of the magnetic powder to a value which falls within a range from 0.1 to 1 μm and, it is more preferable to set the average particle size to a value which falls within a range from 0.1 to 0.5 μm.

The reason is that the magnetic powder having the average particle size is easy to handle and it may be possible to uniformly disperse the magnetic powder into the binder resin in a fine powdery form without generating the aggregation of the magnetic powder.

Further, it may be preferable to apply surface treatment to the magnetic powder by using a surface treatment agent such as a titanium-based coupling agent or a silane-based coupling agent.

The reason is that, by carrying out the surface treatment in this manner, it may be possible to improve hygroscopic property of the magnetic powder and the dispersion property of the magnetic powder with respect to the binder resin.

Further, assuming the total quantity of the toner as 100 weight %, it may be preferable to set the addition quantity of the magnetic powder to a value which falls within a range from 30 to 50 weight %.

The reason is that when the addition quantity of the magnetic powder is less than 30 weight %, conveying property of the toner is significantly lowered and hence, there is a case in which the image density is lowered, while when the addition quantity of the magnetic powder exceeds 50 weight %, there may arise a case in which the environment resistance property is lowered. Particularly, under a high temperature and high moisture condition, an insufficient charge and a defective image are generated leading to drawbacks such as contamination of a photoreceptor or the like.

2. Inorganic Particles

Further, as added particles or compounded particles with respect to the toner, it may be preferable to add inorganic fine particles.

As a type of such inorganic fine particles, it may be possible to use two or more kinds of titanium oxide, aluminum oxide, dry silica, wet silica, titanium oxide, hydrophobic silica, aluminum oxide, zirconium oxide or the like in a single form or in combination.

Further, as titanium oxide, anatase-type titanium oxide and rutile-type titanium oxide are known and either titanium oxide may be favorably used. However, since the anatase type titanium oxide exhibits more improved charge property under a high temperature and high moisture condition, it may be preferable to use the anatase type titanium oxide.

Further, when silica is used, it may be preferable to use hydrophobic silica since hydrophobic silica exhibits the more improved charge property under a low temperature and low moisture condition.

Further, although a preferred average particle size of the inorganic fine particles depending on a kind of inorganic fine particles, when titanium oxide or the like is used as the inorganic fine particles, it may be preferable to set the average particle size of the organic fine particles to a value which falls within a range from 0.1 to 1.0 μm.

On the other hand, when hydrophobic silica is used as the inorganic fine particles, it may be preferable to set the average particle size of hydrophobic silica to a value which falls within a range from 0.005 to 0.02 μm.

The reason is that, by respectively setting average particle sizes of titanium oxide and hydrophobic silica to values which fall within predetermined ranges, it may be possible to improve the handling property, to effectively prevent charge-up and, further, to effectively prevent lowering of the image density under a low temperature and low moisture condition, fogging or the like.

Further, it may be preferable that surfaces of the inorganic fine particle are treated by using a silane compound or a titanium compound. The reason is that, by applying such a surface treatment, it may be possible to easily introduce a hydrophobic group into the surfaces of the inorganic fine particles. Accordingly, by using the first inorganic fine particles to which the surface treatment has been applied in this manner, it may be possible to prevent the lowering of charge property particularly under a high temperature and high moisture condition.

Here, as the favorable silane compound or titanium compound, vinyltrimethoxysilane, naphthyl trimethoxysilane, Phenyl trimethoxysilane, methyl trimethoxysilane, ethyl trimethoxysilane, propyl trimethoxysilane, isobutyl trimethoxysilane, octadecyl trimethoxysilane, naphthyl triethoxysilane, Phenyl triethoxysilane, methyl triethoxysilane, ethyl triethoxysilane, propyl triethoxysilane, isobutyl triethoxysilane, octadecyl triethoxysilane, isopropyl tri isosteraroyl titanium, vinyltrimethoxy titanium, naphthyl trimethoxy titanium or the like can be named.

Further, besides such silane compound and titanium compound, it may be preferable that the inorganic fine particles are treated with other hydrophobization treatment agent. As a favorable hydrophobization treatment agent, silicone oil such as dimethyl silicone oil, methylphenyl silicone oil, α-methylstyrene degeneration silicone oil, chlorophenyl silicone oil, fluorine degeneration silicone oil or silicone varnish such as methyl silicone varnish, Phenyl methyl silicone varnish can be named.

Here, when the inorganic fine particles are treated with the silane compound or the hydrophobization treatment agent, it may be preferable that the hydrophobicity of the inorganic fine particles which is measured by using the methanol method is set to a value which falls within a range from 45 to 65%.

The reason is that, when the hydrophobicity is less than 45%, there may arise a case in which charge property is significantly lowered under a high temperature and low moisture condition, while when the hydrophobicity exceeds 65%, there may arise a case in which charge-up is easily generated.

Accordingly, it is more preferable to set the hydrophobicity of the inorganic fine particles to a value which falls within a range from 47 to 62%, and it is further preferable to set the hydrophobicity of the inorganic fine particles to a value which falls within a range from 50 to 60.

Further, it may be preferable to set volume resistivity of the inorganic fine particles to a value which falls within a range from 1×10⁵ to 1×10⁹ Ohm·cm.

The reason is that when volume resistivity is less than 1×10⁵ Ohm·cm, there may arise a case in which charge property of the toner is significantly lowered under a high temperature and high moisture condition, while when volume resistivity exceeds 1×10⁹ Ohm·cm, there may also arise a case in which the charge-up is liable to easily occur, the image density is lowered or fogging is generated under a low temperature and low moisture condition.

Accordingly, it is more preferable to set volume resistivity of the inorganic fine particles to a value which falls within a range from 1×10⁶ to 1×10⁸ Ohm·cm, and it is still more preferable to set volume resistivity of the inorganic fine particles to a value which falls within a range from 1×10⁶ to 1×10⁷ Ohm·cm.

Further, with respect to an addition quantity of the inorganic fine particles, although the addition quantity of the inorganic fine particles depends on a kind of the inorganic fine particles, when the inorganic fine particles are fine particles such as hydrophobic silica or the like, it may be preferable to set the addition quantity of the hydrophobic silica to a value which falls within a range from 0.5 to 2.0 weight % with respect to a total quantity.

On the other hand, when the particle size of metal oxide or the like is relatively large, it may be preferable to set the addition quantity of the metal oxide to a value which falls within a range from 1.0 to 3.0 weight % with respect to a total quantity.

The reason is that by setting the addition quantity of the inorganic fine particles to a value which falls within a predetermined range, it may be possible to allow the toner to obtain the predetermined heat resistance and, at the same time, the toner can maintain a photoreceptor polishing ability in a stable manner, the charge-up can be effectively prevented, and drawbacks such as the lowering of the image density under a low temperature and low moisture condition can be effectively prevented.

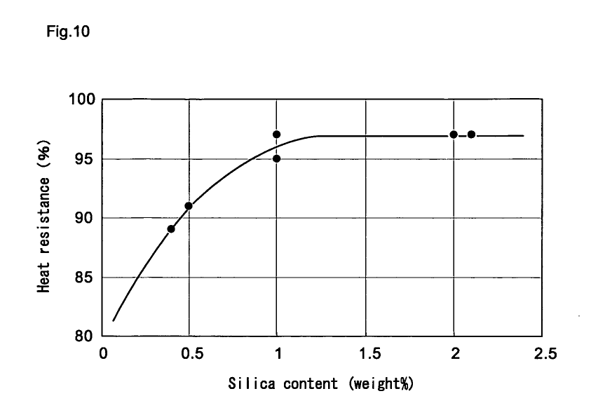

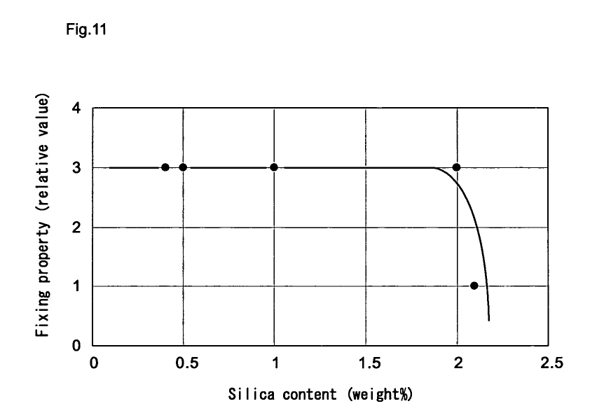

Here, in FIG. 10 and FIG. 11, a relationship between silica content and heat resistance which is prescribed in the example 1 and a relationship between silica content and fixing property which is prescribed in the example 1 are respectively shown. That is, in FIG. 10 and FIG. 11, by using real numbers with respect to heat resistance of the toner and by using relative evaluation (G: evaluation point being 3, F: evaluation point being 2, B: evaluation point being 1) which is obtained with respect to fixing property, the relationships are respectively shown.

As can be understood from characteristic curves shown in FIG. 10 and FIG. 11, by controlling the silica content to a value which falls within a predetermined range, it may be possible to respectively obtain excellent properties in heat resistance (%) and fixing property (relative evaluation) which conflict to each other. Accordingly, to obtain predetermined heat resistance and fixing property of the toner, it is effective to limit the silica content to a predetermined range.

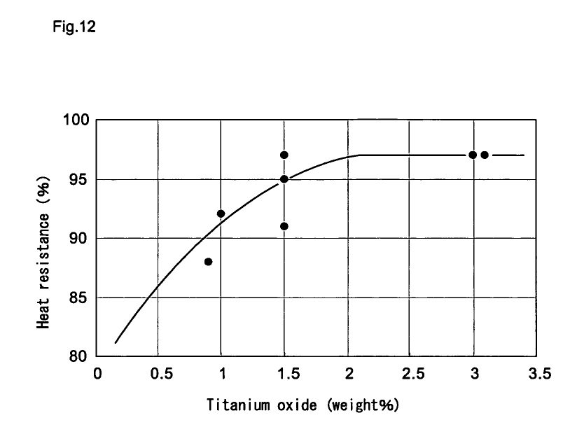

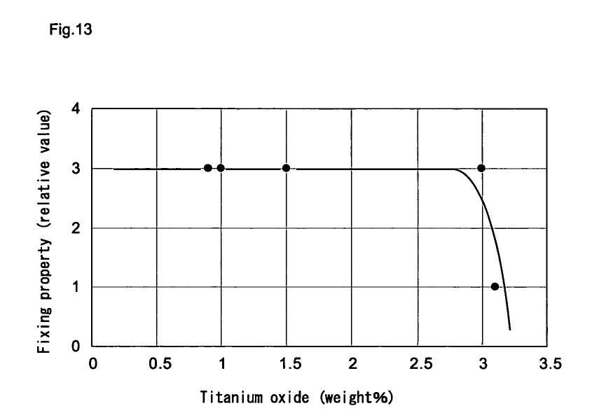

Further, in the same manner, in FIG. 12 and FIG. 13, a relationship between content of titanium oxide as a metal oxide and heat resistance which is prescribed in the example 1 and a relationship between content of titanium oxide and fixing property which is prescribed in the example 1 are respectively shown. That is, in FIG. 12 and FIG. 13, by using real numbers with respect to heat resistance of the toner and by using relative evaluation (G: evaluation point being 3, F: evaluation point being 2, B: evaluation point being 1) which is obtained with respect to fixing property, the relationships are respectively shown.

As can be understood from a characteristic curve shown in FIG. 12 and FIG. 13, by controlling the content of the titanium oxide to a value which falls within a predetermined range, it may be possible to respectively obtain excellent properties in heat resistance (%) and fixing property (relative evaluation) which conflict to each other. Accordingly, to allow the toner to obtain predetermined heat resistance and fixing property of the toner, it is effective to limit the content of the titanium oxide to a predetermined range.

3. Average Particle Size

Further, although an average particle size of the toner particles is not particularly limited, it may be preferable to set the average particle size of the toner particles to a value which falls within a range from 5 to 12 μm.

The reason is that, when the average particle size of the toner particles is less than 5 μm, there may arise a case in which charge property or fluidity of the toner particles is lowered and, further, an isolation rate of the added particle is raised, while when the average particle size of the toner particles exceeds 12 μm, there may arise a case in which fluidity of the toner is lowered due to a shortage of the additive or an image quality is deteriorated.

Accordingly, it is more preferable to set the average particle size of the toner to a value which falls within a range from 6 to 11 μm, and it is still more preferable to set the average particle size of the toner to a value which falls within a range from 7 to 10 μm.

Here, the average particle size is measured by using a laser-method particle size distribution meter.

4. Powder Test

Further, it may be preferable that a 140 mesh passing ratio in a powder test after a heat treatment at a temperature of 50° C. for 100 hours is 90% or more.

The reason is that, due to such a constitution, a further appropriate magnetic monocomponent developing toner can be prescribed with respect to the image forming apparatus which includes a spiral developing unit or the like.

Here, the powder test can be carried out in the same manner as described in the example 1 which will be described later.

5. Developing Unit

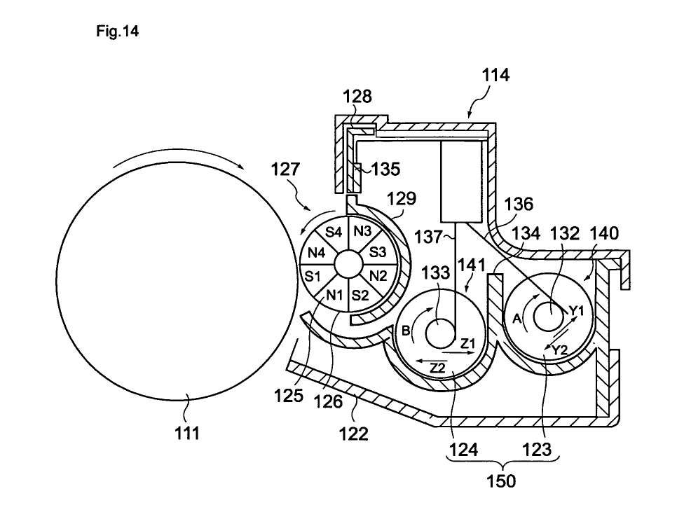

Further, as a developing unit which is used in the present invention, as shown in FIG. 14, it may be possible to use a developing unit 114 which includes a developing container 122 for accommodating the developer, a developer carrying body 127 for holding the developer and conveying the developer to a developing region, a developer layer thickness restricting member 128 for restricting a layer thickness of the developer, spiral members 150 which are rotated with respect to predetermined rotation axes as centers of rotation and convey the developer in the rotation axis direction.

Here, the spiral members 150 are constituted of a first spiral member 123 and a second spiral member 124 which constitute conveying means for conveying the toner particles in a predetermined direction and a toner removing member 136 for removing the toner particles which are adhered to the spiral members 123, 124.

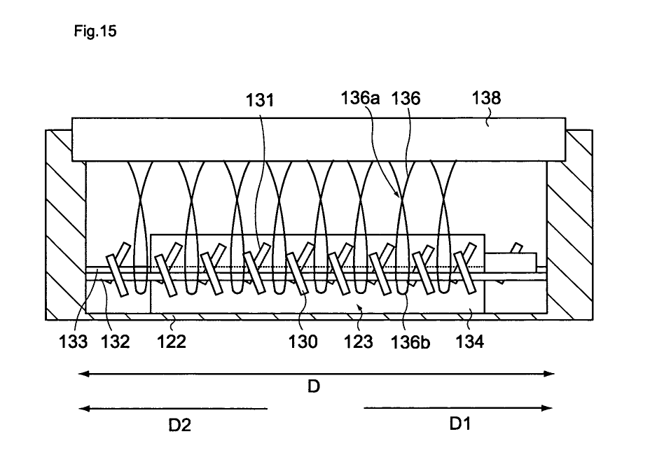

To be more specific, as shown in FIG. 15, the spiral member 150 are provided with the first spiral member 123 which is formed of a shaft 132 which constitutes a rotatable first shaft arranged in the inside of an agitating chamber 140 for agitating the toner particles and spiral blades 130 which are mounted on a peripheral surface of the shaft 132, wherein by rotating the first spiral member 123 in the direction indicated by an arrow A in the drawing, the toner is conveyed in the longitudinal direction of the shaft 132 (direction indicated by an arrow D in FIG. 15).

Further, as shown in FIG. 15, the spiral member 150 is provided with the second spiral member 124 which is formed of a shaft 133 which constitutes a second rotatable second shaft arranged substantially parallel to the shaft 132 and spiral-like blades 131 which are mounted on a peripheral surface of the shaft 133, wherein by rotating the second spiral member 124 in the direction indicated by an arrow B in the drawing, the toner is conveyed in the longitudinal direction of the shaft 133 (direction indicated by an arrow D in FIG. 15).

Here, the first spiral member 123 and the second spiral member 124 are arranged in approximately parallel to each other. Further, between the first spiral member 123 and the second spiral member 124, a partition member 134 which divides the agitation chamber 140 and the developing chamber 141 in a state that the agitation chamber 140 and the developing chamber are 141 communicable with each other is provided. Accordingly, it may be possible to convey the toner while agitating the toner in a circulating manner.

Further, as shown in FIG. 14, the developing unit includes a fixing magnet roller 125 which is arranged on a drum opening side of the developing container 122 and has a plurality of magnetic poles, the developer carrying body 127 which includes a non-magnetic developing sleeve 126 which accommodates the fixed magnet roller 125 in the inside thereof and is pivotally and rotatably supported for introducing the accommodated toner to the surface of the photoreceptor 111.

Further, the developing unit includes a developer layer thickness restricting member 128 which is formed of a plate-like magnetic body and is arranged in the vicinity of the developing sleeve 126 and extends downwardly toward an upper surface of the developing sleeve 126 and a magnetic body sealing member 129 which is arranged at an end portion of the developing sleeve 126 in the longitudinal direction. Further, the developing unit includes a magnet body 135 which is mounted on a side wall surface of the developer layer thickness restricting member 128 on a developing container 122 side, wherein an S pole is provided to a lower end thereof and a developing bias (not shown in the drawing) is applied to the developing roller 33.

Further, a toner replenishing hole (not shown in the drawing) is opened above the first spiral member 123 so as to allow the supply of the toner therethrough. That is, the supplied toner is carried in the inside of the agitating chamber 140 by using the first spiral member 123 while being agitated from the left end in FIG. 14 in the right direction, that is, in the direction indicated by an arrow D1 in the drawing with respect to the longitudinal directions D of the shaft 132 and is introduced into the developing chamber 141. The toner which is introduced into the developing chamber 141 is conveyed while being agitated in the inside of the developing chamber 141 by the second spiral member 124 in the left direction from the right end in FIG. 14, that is, in the direction indicated by an arrow D2 in the drawing with respect to the longitudinal directions D of the shaft 132 and is introduced into the developing sleeve 126. The toner which is introduced into the developing sleeve 126 is carried on the developing sleeve 126 by making use of a magnetic force of the fixed magnet roller 125 and, a thickness of the toner is restricted by the developer layer thickness restricting member 128 which is arranged in the vicinity of the developing sleeve 126.

Next, the toner which is carried on the developing sleeve 126 is guided to a developing position, that is, a surface of the photoreceptor 111 by the developer carrying body 127 and, due to a contact between the photoreceptor 111 and a printing paper, an image is transferred and formed on the printing paper.

Further, as shown in FIG. 14, on the first spiral member 123 and the second spiral member 124, toner removing members 136, 137 for removing the toner adhered to the spiral members are mounted.

To be more specific, the toner removing member 136 is arranged in a state that at least a portion of the toner removing member 136 is brought into contact with a surface of the first spiral member 123 in the inside of the developing container 122 and is supported on a supporting member 138 which is mounted in the inside of the container 122. Further, in the same manner, the toner removing member 137 is arranged in a state that at least a portion of the toner removing member 137 is brought into contact with a surface of the second spiral member 124 in the inside of the developing container 122 and is supported on a supporting member 138 which is mounted in the inside of the developing container 122.

Here, the toner removing members 136, 137 may be formed of a metal wire having a predetermined elastic modulus by taking a toner removing effect and durability into consideration.

Further, as shown in FIG. 15, the toner removing portion 136 includes a twisted portion 136a, wherein the twisted portion 136a is formed in a state that a cross-sectional shape of a portion 136b which is brought into contact with the surface of the first spiral member 123 in the direction orthogonal to the longitudinal direction D of the shaft 132 of the first spiral member 123 (the directions indicated by arrows Y1, Y2 in FIG. 14) (hereinafter, referred to as “toner scraping portion 136b”) has an approximately elliptical shape.

Here, although only the toner removing member 136 is shown in FIG. 15, the toner removing member 137 also has the same shape as the toner removing member 136. That is, a twisted portion (not shown in the drawing) is formed on the toner removing member 137 and is formed in a state that a cross-sectional shape of a portion of the toner removing member 137 which is brought into contact with the surface of the second spiral member 124 in the direction (the directions indicated by arrows Z1, Z2 in FIG. 14) which intersects the longitudinal direction D of the shaft 133 of the second spiral member 124 at a right angle exhibits an approximately elliptical shape.

That is, in a process of conveying the developer from the developing container 122 to the photoreceptor 111, the developer receives a dynamic stress when the developer is brought into contact with a spiral spring which includes the spiral member and the toner removing member. Then, for example, even when stress is continuously applied to the developer by the spiral spring under a high temperature environment where a temperature is 30° C. or more, it may be possible to effectively prevent the generation of drawbacks such as aggregation or image vertical streaks.

### Second Embodiment

The second embodiment is directed to an image forming method which is characterized in that the magnetic monocomponent developing toner of the present invention is used in a developing unit which includes a developer carrying body which carries a developer and transports the developer to a developing region, and a developer layer thickness restricting member which restricts a layer thickness of the developer carried on the developer carrying body, and arranges a magnetic body in the vicinity of the developer carrying body.

Hereinafter, the constitutions of the present invention which are explained already in conjunction with the first embodiment are omitted and the explanation is made by focusing on points which make the second embodiment different from the first embodiment.

1. Image Forming Apparatus

(1) Constitution

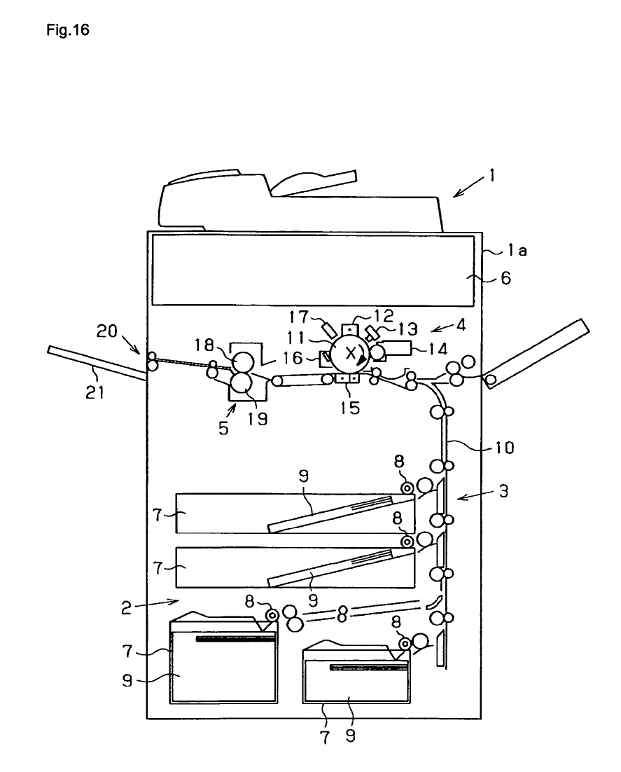

In performing the image forming method according to the second embodiment, it may be possible to favorably apply the image forming method to an image forming apparatus 1 shown in FIG. 16.

Here, FIG. 16 is a schematic view showing the whole constitution of the image forming apparatus. The image forming apparatus 1 includes a paper feeding part 2 which is arranged in a lower portion of the image forming apparatus body 1a, a paper conveying part 3 which is arranged on a side of and above the paper feeding part 2, an image forming part 4 which is arranged above the paper conveying part 3, a fixing part S which is arranged at a position closer to a discharge side than the image forming part 4, and an image reading part 6 which is arranged above the image forming part 4 and the fixing part 5.

Further, the paper feeding part 2 includes a plurality of (four in the embodiment) paper feeding cassettes 7 which stores papers 9. Due to a rotational operation of a paper feeding roller 8, the papers 9 are fed to the paper conveying part 3 side from the paper feeding cassette 7 which is selected from the plurality of paper feeding cassettes 7 so as to surely feed the papers 9 one by one to the paper conveying part 3. Here, these four paper feeding cassettes 7 are detachably mounted on the image forming apparatus body 1a.

Further, the paper 9 which is fed to the paper conveying part 3 is conveyed toward the image forming part 4 via a paper feeding path 10. The image forming part 4 is provided for forming a predetermined toner image on the paper 9 using an electrophotographic process. The image forming part 4 includes a photoreceptor 11 which constitutes an image carrying body and is pivotally supported in a state that the photoreceptor 11 can be rotated in the predetermined direction (in the direction indicated by an arrow X in the drawing) and also includes a charging device 12, an exposure device 13, a developing unit 14, a transfer device 15, a cleaning device 16 and a charge elimination device 17 which are arranged in the periphery of the photoreceptor 11 and along the rotational direction of the photoreceptor 11.

Further, the charging device 12 includes charging wires to which a high voltage is applied. By applying a predetermined potential to a surface of the photoreceptor 11 by making use of corona discharge generated by the charging wires, the surface of the photoreceptor 11 is uniformly charged. Then, in the exposure device 13, light based on image data of an original which is read by the image reading part 6 is radiated to the photoreceptor 11. Accordingly, the surface potential of the photoreceptor 11 is selectively attenuated and an electrostatic latent image is formed on the surface of the photoreceptor 11. Next, the toner is adhered to the electrostatic latent image by using the developing unit 14, the toner image is formed on the photoreceptor 11 and, thereafter, the toner image on the surface of the photoreceptor 11 is transferred to the paper 9 which is supplied between the photoreceptor 11 and the transfer device 15 using the transfer device 15.

Further, the paper 9 to which the toner image is transferred is conveyed toward the fixing part 5 from the image forming part 4. The fixing part 5 is arranged on a downstream side of the image forming part 4 in the paper conveying direction. The paper 9 to which the toner image is transferred in the image forming part 4 is sandwiched between a heating roller 18 and a pressing roller 19 which is brought into pressure contact with the heating roller 18 which are provided in the fixing part 5, wherein the paper 9 is also heated by the heating roller 18 whereby the toner image is fixed to the paper 9. Next, the paper 9 on which the image is formed through steps of the image forming part 4 and the fixing part 5 is discharged to a discharge tray 21 by a pair of discharge rollers 20.

On the other hand, the toner remaining on the surface of the photoreceptor 11 is removed using a cleaning device 16. Here, a residual charge on the surface of the photoreceptor 11 is removed using a charge elimination device 17 and the photoreceptor 11 is charged again using the charging device 12. The image is formed by repeating the same steps hereinafter. Here, with the use of the magnetic monocomponent developing toner which satisfies predetermined conditions with respect to the developing unit which includes a spiral member as an agitating conveying means, stress resistance of toner particles is enhanced. Accordingly, even when the use environment is changed, there is no possibility that the toner aggregates and it may be possible to allow the toner to possess excellent fluidity. Accordingly, even in an environment in which the toner is easily influenced by stress, it may be possible to obtain excellent aggregation resistance and heat resistance while assuring a balance between these properties and the fixing property.

2. Magnetic Monocomponent Developing Toner

The magnetic monocomponent developing toner which is used in a second embodiment can be favorably used for toner particles including a binder resin and magnetic powder provided that the magnetic monocomponent developing toner is a magnetic monocomponent developing toner in which a predetermined quantity of inorganic fine particles or the like is added. Here, details of the magnetic monocomponent developing toner may be set equal to the details of the magnetic monocomponent developing toner explained in conjunction with the first embodiment.

### EXAMPLE

Hereinafter, the present invention is further explained in detail in conjunction with the examples. Here, it is needless to say that the explanation of the present invention is provided only for an illustration purpose and the scope of the present invention is not limited to the following explanation without unless otherwise specified.

### Example 1

1. Formation of Toner

(1) Formation of Toner Particles

First of all, a plurality of polyester resins is used as a binder resin and magnetic powder or the like is mixed into the binder resin and, thereafter, these resins are melted and mixed.

That is, first of all, polyester resins A and B are respectively formed. With respect to the polyester resin A, 2000 g of 2.2 mol adduct of bisphenol-A propylene oxide, 800 g of 2.2 mol additive of bisphenol-A ethylene oxide, 500 g of terephthalic acid, 600 g of n-dodecenylsuccinic acid, 350 g of trimellitic acid anhydride and 4 g of dibutyl tin oxide are accommodated in a reaction container and, thereafter, these components are subjected to a condensation reaction at a temperature of 220° C. for 8 hours while being agitating in a nitrogen atmosphere. Thereafter, the condensation reaction is continued until a softening point reaches at 155° C. under a reduced pressure.

Further, with respect to the polyester resin B, 2800 g of 2.2 mol additive of bisphenol-A propylene oxide, 400 g of terephthalic acid, 650 g of fumaric acid and 4 g of dibutyltin oxide are accommodated in a reaction container and, thereafter, the components are subjected to a condensation reaction at a temperature of 220° C. for 8 hours while being agitating in a nitrogen atmosphere. Then, the condensation reaction is continued until a softening point reaches at 90° C. under reduced pressure.

Then, 30 parts by weight of the polyester resin A (Tg: 60° C., a softening point: 150° C., an acid value: 7.0, a gel fraction: 30%) and 70 parts by weight of the polyester resin B (Tg: 50° C., a softening point: 100° C., an acid value: 4.0, a gel fraction: none) which are obtained in this manner as well as 75 parts by weight of magnetic powder body (product name: MTSB-905, made by TODA KOGYO CORP.), 3 parts by weigh of CCA (product name: Bontoron No. 1, made by Orient Chemical Industries, Ltd.) as charge control component, 8 parts by weight of charge control resin (quaternary ammonium salt-additive styrene-acrylic copolymer; made by Fujikura Kasei Co. Ltd. FCA196), 3 parts by weight of ester wax (solid fatty acid ester having high purity: impurities 0.01% or less, melting temperature region 75° C. to 85° C. obtained by a condensation reaction of straight-chain monocarboxylic acid (carbon number 20 to 30) and straight chain saturated monohydric alcohol (carbon number 20 to 30)) are mixed by a Henschel mixer as a wax component.

Next, after the compositions are further mixed by using a twin screw extruder (cylinder setting temperature: 100° C.), the compositions are roughly pulverized by a feather mill. Then, the compositions are finely pulverized by a turbo mill and are classified by an air classifier whereby toner particles having an average particle size of 8.0 μm are obtained.

(2) Addition of Inorganic Particles

To 100 parts by weight of obtained toner particles, 1.0 part by weight of silica (product name: RA200HS, made by NIPPON AEROSIL CO., LTD.) and 1.5 parts by weight of titanium oxide (product name: EC100T1, made by Titan Kogyo Co., Ltd.) are added and mixed by the Henschel mixer thus producing the magnetic toner 1.

2. Evaluation of Toner

With respect to the obtained magnetic toner 1, heat resistance, fixing property and image property are respectively evaluated by using a page printer (Ecosys FS-9500DN) made by KYOCERA Corporation. The obtained evaluation results are shown in Table 2.

(1) Evaluation of Heat Resistance (Powder Test)

3 g of the produced magnetic toner 1 is weighed and is accommodated in a container made of polyethylene having a size of 20 cm³ under a condition in which a temperature is 20° C. and a moisture is 60% Rh and, thereafter, is covered with a lid and is sealed. Next, by using an oven, a heat treatment is carried out at a temperature of 50° C. (DRY) for 100 hours. Next, after controlling temperature and moisture in an atmosphere in which the temperature is 20° C. and the moisture is 60% Rh for 8 hours, the toner is placed on a sieve of 140 mesh and a pan and is vibrated under a condition of vibration number scale 5 and for 30 seconds as period by using a powder tester (Powdertech Co., Ltd.).

Next, the weight of the toner which remains on a 140 mesh sieve after the vibration treatment is weighed and a weight changing ratio is calculated by the following formula and is evaluated as heat resistance (%).
heat resistance (%)=(quantity of toner before vibration treatment(g)−toner remaining on 140 mesh (g))×100/(quantity of toner before vibration treatment(g)) [Formula 2]

TABLE 1

| | | | | | Wax | Wax | | |
|---|---|---|---|---|---|---|---|---|
| | | | THF- | | melting | melting | | |
| | | | Insoluble | | starting | finishing | | titanium |
| Magnetic | | | component | Tg | point | point | Silica | oxide |
| toner | Peak A | Peak B | (%) | (° C.) | (° C.) | (° C.) | (%) | (%) |
| 1 | 2.0 × 10⁶ | 2.1 × 10⁴ | 9 | 53.0 | 75 | 85 | 1.0 | 1.5 |
| 2 | 1.0 × 10⁶ | 2.0 × 10⁴ | 9 | 52.0 | 75 | 85 | 1.0 | 1.5 |
| 3 | 4.9 × 10⁶ | 2.1 × 10⁴ | 9 | 54.5 | 75 | 85 | 1.0 | 1.5 |
| 4 | 2.0 × 10⁶ | 1.0 × 10⁴ | 9 | 51.5 | 75 | 85 | 1.0 | 1.5 |
| 5 | 2.0 × 10⁶ | 5.0 × 10⁴ | 9 | 55.0 | 75 | 85 | 1.0 | 1.5 |
| 6 | 1.4 × 10⁶ | 2.1 × 10⁴ | 5 | 52.5 | 75 | 85 | 1.0 | 1.5 |
| 7 | 1.9 × 10⁶ | 2.0 × 10⁴ | 6 | 51.0 | 75 | 85 | 1.0 | 1.5 |
| 8 | 2.2 × 10⁶ | 2.5 × 10⁴ | 12 | 55.0 | 75 | 85 | 1.0 | 1.5 |
| 9 | 2.0 × 10⁶ | 2.1 × 10⁴ | 9 | 53.0 | 71 | 84 | 1.0 | 1.5 |
| 10 | 2.0 × 10⁶ | 2.1 × 10⁴ | 9 | 53.0 | 78 | 90 | 1.0 | 1.5 |
| 11 | 2.0 × 10⁶ | 2.1 × 10⁴ | 9 | 53.0 | 75 | 85 | 0.5 | 1.5 |
| 12 | 2.0 × 10⁶ | 2.1 × 10⁴ | 9 | 53.0 | 75 | 85 | 2.0 | 1.5 |
| 13 | 2.0 × 10⁶ | 2.1 × 10⁴ | 9 | 53.0 | 75 | 85 | 1.0 | 1.0 |
| 14 | 2.0 × 10⁶ | 2.1 × 10⁴ | 9 | 53.0 | 75 | 85 | 1.0 | 3.0 |
| 15 | 9.0 × 10⁵ | 2.1 × 10⁴ | 9 | 50.5 | 75 | 85 | 1.0 | 1.5 |
| 16 | 5.5 × 10⁶ | 2.1 × 10⁴ | 9 | 55.6 | 75 | 85 | 1.0 | 1.5 |
| 17 | 2.0 × 10⁶ | 9.0 × 10³ | 9 | 50.4 | 75 | 85 | 1.0 | 1.5 |
| 18 | 2.0 × 10⁶ | 5.6 × 10⁴ | 9 | 56.0 | 75 | 85 | 1.0 | 1.5 |
| 19 | 1.4 × 10⁶ | 2.1 × 10⁴ | 4 | 52.5 | 75 | 85 | 1.0 | 1.5 |
| 20 | 2.0 × 10⁶ | 2.1 × 10⁴ | 9 | 53.0 | 69 | 83 | 1.0 | 1.5 |

(2) Evaluation of Fixing Property

By using a remodeled machine of an image forming apparatus LS-9500 made by Kyocera Mita Corporation, at a normal temperature and a normal moisture (temperature: 20° C., moisture: 65% Rh), the evaluation of fixing property with respect to the magnetic toner 1 is performed.

That is, a fixing temperature of the image forming apparatus (LS-9500 remodeled machine) is stabilized at 150° C., and 10 sheets of matted image (25×25 mm) are sequentially printed by using a thick paper (160 mg paper) A4. Next, a matted image density (1 point×10 sheets, 10 points in total) is measured by a reflection density meter (TC-6DS, made by Tokyo Denshoku Co., Ltd.) as an image density before rubbing. Next, a bottom of an weight of 1 Kg (4 cm×5 cm×6 cm) is wrapped with a bleached cotton cloth, and the weight is made to reciprocate on the solid image 10 times by deadweight thereof and to rub the solid image and, thereafter, the solid image density as the image density after rubbing is measured. Then, by the image density before rubbing and the image density after rubbing which are measured, fixing property (%) is calculated based on the following formula.
fixing property (%)=(image density after rubbing)/(image density before rubbing)×100

Here, the evaluation criteria with respect to the fixing property are as follows.

Good(G): Fixing property is equal to or more than 95%.

Fair(F): Fixing property is less than 95% and equal to or more than 90%.

Bad(B): Fixing property is less than 90%.

(3) Evaluation of Image

Further, 20,000 sheets having a printing ratio of 4.0% are sequentially printed under a high temperature and normal moisture environmental condition in which a temperature is 35° C. and a moisture is 60% RH and, thereafter, the presence or absence of vertical streaks on a sleeve and on a formed image is confirmed. Here, the evaluation criteria with respect to the evaluation of image are as follows.

Good(G): There are no streaks on the sleeve and on the image.

Fair(F): Although there are streaks on the sleeve, there are no streaks on the image.

Bad (B): There are streaks on the sleeve and on the image respectively.

Here, a developing condition, a fixing condition and a charger condition before transferring at the time of printing 20000 sheets by using a remodeled machine of an image forming apparatus LS-9500 made by Kyocera Mita Corporation under an environment in which a temperature is 35° C. and a moisture is 60% Rh are as follows.

[Developing Condition]

developing method: dry type monocomponent jumping development

photoreceptor drum peripheral speed: 440 mm/sec

photoreceptor potential: 400V

developing DC bias: 300V

developing AC PEAK to PEAK: 1.5 KV

developing AC frequency number: 2.5 KHz

### Examples 2 to 14 and Comparison Examples 1 to 6

In the examples 2 to 14 and the comparison examples 1 to 6, in the same manner as the example 1, heat resistance, fixing property and image property are respectively evaluated.

That is, in the examples 2, 3 and the comparison examples 1, 2, magnetic toners 2, 3, 15, 16 are obtained in the same manner as the example 1 except for that only polymerization condition (reaction period) of polyester resin A is changed and evaluated.

Further, in the examples 4, 5 and the comparison examples 3, 4, magnetic toners 4, 5, 17 and 18 are obtained in the same manner as the example 1 except for that only polymerization condition (reaction period) of polyester resin B is changed and evaluated.

Further, in the example 6 and the comparison example 5, gel quantity of polyester resin A is changed thus obtaining magnetic toners 6, 19.

Further, in the example 7, 8, a mixing ratio of polyester resins A, B is changed thus obtaining magnetic toners 7, 8.

Further, in the examples 9, 10 and the comparison example 6, carbon numbers of monocarbixylic acid and saturated monohydric alcohol as contract reaction material of wax are changed thus obtaining magnetic toners 9, 10, 20.

Further, in examples 11 to 14, an addition quantity of surface treatment agent is changed thus obtaining magnetic toners 11 to 14.

TABLE 2

| | | | | | After printing 2000 sheets | | |
|---|---|---|---|---|---|---|---|
| | | Heat | Fixing property | | at high temperature | | |
| | Magnetic | resistance | Fixing | | streaks on | streaks on | |
| Embodiment | toner | (%) | property(%) | Evaluation | sleeve | image | Evaluation |
| 1 | 1 | 95 | 98 | G | A | A | G |
| 2 | 2 | 92 | 99 | G | P | A | F |
| 3 | 3 | 96 | 94 | F | A | A | G |
| 4 | 4 | 90 | 98 | G | A | A | G |
| 5 | 5 | 97 | 92 | F | A | A | G |
| 6 | 6 | 91 | 98 | G | A | A | G |
| 7 | 7 | 90 | 99 | G | P | A | F |
| 8 | 8 | 97 | 92 | F | A | A | G |
| 9 | 9 | 90 | 99 | G | A | A | G |
| 10 | 10 | 96 | 94 | F | A | A | G |
| 11 | 11 | 91 | 98 | G | A | A | G |
| 12 | 12 | 97 | 96 | G | A | A | G |
| 13 | 13 | 92 | 98 | G | P | A | F |
| 14 | 14 | 97 | 93 | G | A | A | G |

P: Presence,
A: Absence

TABLE 3

| | | | | | After printing 2000 sheets | | |
|---|---|---|---|---|---|---|---|
| | | Heat | Fixing property | | at high-temperature | | |
| comparative | Magnetic | resistance | Fixing | | Streaks on | Streaks on | |
| example | toner | (%) | property(%) | Evaluation | sleeve | image | Evaluation |
| 1 | 15 | 85 | 99 | G | P | P | B |
| 2 | 16 | 96 | 88 | B | P | P | B |
| 3 | 17 | 84 | 98 | G | P | P | B |
| 4 | 18 | 97 | 84 | B | P | P | B |
| 5 | 19 | 87 | 98 | G | P | P | B |
| 6 | 20 | 86 | 99 | G | P | P | B |

According to the results shown in Table 2 and Table 3, it is evaluated that the examples 1 to 14 are at levels in which there is no problem in practical use with respect to the fixing property and the image evaluation (high temperature and normal moisture condition).

On the other hand, the comparison examples 1 to 6 can not satisfy performance in practical use with respect to either one of the fixing property and the image evaluation (high temperature and normal moisture condition).

What we claim is:

1. A magnetic monocomponent developing toner comprising 45 to 65 weight % of a binder resin, 1 to 15 weight % of wax, and 30 to 50 weight % of magnetic powder with respect to a total quantity of the toner, wherein
the binder resin contains a first binder resin having a weight average molecular weight peak within a range from 1.0×10⁴ to 5.0×10⁴ and a second binder resin having a weight average molecular weight peak within a range from 1.0×10⁶ to 5.0×10⁶, and contains 5 to 30 weight % of tetrahydrofuran-insoluble component with respect to the total quantity of the binder resin,
the wax is made of an ester compound or a Fischer Tropsch wax, and
the wax has melting property that a temperature range from starting of melting to finishing of melting is set to 70 to 95° C.

2. The magnetic monocomponent developing toner according to claim 1, wherein a softening point of the first binder resin is set to less than 120° C. and, at the same time, a softening point of the second binder resin is set to 120° C. or more.

3. The magnetic monocomponent developing toner according to claim 1, wherein the first binder resin and the second binder resin are respectively formed of a first polyester resin and a second polyester resin, wherein an acid value of the first polyester resin is less than 6 mgKOH/g and, at the same time, an acid value of the second polyester resin is equal to or more than 6 mgKOH/g.

4. The magnetic monocomponent developing toner according to claim 3, wherein the second polyester resin is formed of a partially cross-linked substance of a polyester resin which contains a bisphenol-A propylene oxide compound as an alcoholic component and, at the same time, the second polyester resin contains 10 to 50 weight % of tetrahydrofuran-insoluble component with respect to a total quantity thereof with respect to a total quantity of the second polyester resin.

5. The magnetic monocomponent developing toner according to claim 3, wherein the first polyester resin is a polyester resin which contains a bisphenol-A propylene oxide compound as an alcoholic component and, at the same time, a content of the tetrahydrofuran-insoluble component is 1 weight % or less with respect to a total quantity of the first polyester resin.

6. The magnetic monocomponent developing toner according to claim 3, wherein the first polyester resin is a polyester resin which contains at least one kind selected from a group consisting of a boletic acid, an erephthalic acid and a trimellitic acid.

7. The magnetic monocomponent developing toner according to claim 3, wherein the second polyester resin is a polyester resin which contains at least one kind selected from a group consisting of a succinic acid, a terephthalic acid and a trimellitic acid.

8. The magnetic monocomponent developing toner according to claim 1, wherein a glass transition point of the first binder resin is set to a value which falls within a range from 55° C. to 65° C. and, at the same time, a glass transition point of the second binder resin is set to a value which falls within a range from 45° C. to 60° C.

9. The magnetic monocomponent developing toner according to claim 1, wherein a glass transition point of the binder resin is set to a value which falls within a range from 51 to 55° C.

10. The magnetic monocomponent developing toner according to claim 1, wherein a mixing ratio between the first binder resin and the second binder resin is set to a value which falls within a range from 10:90 to 50:50.

11. The magnetic monocomponent developing toner according to claim 1, wherein a 140 mesh passing ratio in a powder test after heat treatment at a temperature of 50° C. for 100 hours is 90% or more.

12. The magnetic monocomponent developing toner according to claim 1, wherein the toner further contains hydrophobic silica as an additive and, at the same time, an addition quantity of the hydrophobic silica is set to a value which falls within a range from 0.5 to 2.0 weight % with respect to the total quantity of the toner.

13. The magnetic monocomponent developing toner according to claim 1, wherein the toner further contains metal oxide as an additive and, at the same time, an addition quantity of the metal oxide is set to a value which falls within a range from 1.0 to 3.0 weight % with respect to the total quantity of the toner.

14. The image forming method being characterized in that the magnetic monocomponent developing toner described in claim 1 is used in a developing unit which includes a developer carrying body which carries a developer and transports the developer to a developing region, and a developer layer thickness restricting member which restricts a layer thickness of the developer carried on the developer carrying body, and arranges a magnetic body in the vicinity of the developer carrying body.

15. The image forming method according to claim 14, wherein the developing unit includes an agitating and transporting member which transports the developer in the rotary shaft direction.
